(19) United States
(12) Patent Application Publication
(10) Pub. No.: US 2002/0063117 A1
(43) Pub. Date: May 30, 2002

(54) Laser sintering of materials and a thermal barrier for protecting a substrate

(76) Inventors: Kenneth H. Church, Stillwater, OK (US); Robert M. Taylor, Perkins, OK (US); Lowell R. Matthews, Stillwater, OK (US); Robert L. Parkhill, Stillwater, OK (US)

Correspondence Address: James C. Wray, Suite 300, 1493 Chain Bridge Road, McLean, VA, 22101, US

(21) Appl. No.: 09/837,265

(22) Filed: Apr. 19, 2001

Related U.S. Application Data
(60) Provisional application No. 60/198,377, filed on Apr. 19, 2000.

(51) Int. Cl. H05B 1/00; H05B 3/00; B23K 9/067

(52) U.S. Cl. 219/200; 219/50

(57) ABSTRACT

A laser sintering method and apparatus has a material on a substrate. A laser is used for completely sintering the material and enhancing adhesion of the material to the substrate without damaging the substrate. Any computing device may receive and process data and automatically control the sintering operation. A protective layer may be provided on the substrate. The substrate may be a low temperature substrate and the protective layer may be a protective thermal barrier which prevents damage to the substrate during sintering and also enhances adhesion of the material to the substrate. The substrate, the material, and the protective thermal barrier may be formed as an electronic component. A feedback control system coupled to the computer provides information to the computer for processing and controlling output of the laser. The material on the substrate may have any shape. The substrate may also have any shape.

TABLE I
Absorbance (in Percent) for Various Materials

at Various Wavelengths of Light

| | | | |
|---|---|---|---|
| Laser Type | XeCl Excimer | Nd:YAG | CO₂ |

| | | | |
|---|---|---|---|
| Wavelength | 308 nm | 1.06 μm | 10.6 μm |
| Metals | | | |
| Silver (Ag) | 90% | 2-3% | 1% |
| Gold (Au) | 62% | 2-3% | 1% |
| Copper (Cu) | 75% | 10% | 2% |
| Platinum (Pt) | 60% | 20% | 4% |
| Palladium (Pd) | 58% | 26% | 4% |
| Metal Oxides | | | |
| Silica (SiC₂) | 2-90% | 2-4% | >90% |
| Titania (TiC₂) | >90% | 30% | >90% |
| Alumina | 85% | 1-10% | 90% |
| (Al₂O₃) | | | |

TABLE II
Material Properties for RTP Simulation

| | Conductivity | Specific Heat | |
|---|---|---|---|
| Material | (W/m-K) | (J/kg-K) | Density |
| Aerogel | 10.0 | 981 | 221 |
| Silver | f₁(T) | 235 | 10,500 |
| Silicon | f₂(T) | 702 | 2,330 |

where

f₁(T)=425+0.07T−0.0002T²+1.03×10⁻⁷T³+1.03×10⁻¹¹T⁴−1.72×10⁻¹⁴T⁵

and;

f₂(T)=445−1.65T+0.0028T²−2.4×10⁻⁶T³+1.0×10⁻⁹T⁴−1.37×10⁻¹³T⁵

This application claims the benefit of U.S. Provisional Application No. 60/198,377 filed Apr. 19, 2000.

### BACKGROUND OF THE INVENTION

Several obstacles currently impede effective laser sintering of materials. One limitation is that current methods inhibit sintering throughout the material. A second problem is that adhesion of the material to a substrate is also inhibited.

Several factors exist that interfere with the propagation of sintering throughout a target material and with the adhesion of the target material to a substrate. A need exists for laser sintering of materials that overcomes these problems.

Existing laser sintering processes damage substrates that are not able to withstand the high temperatures associated with the laser sintering process. Substrates for directly written electronic circuitry are generally some type of plastic. Unfortunately, the highest temperatures known plastics can survive without degradation are on the order of 350° C. Relatively few formulations can even survive at 200° C. In contrast, most materials of utility in constructing electronics (e.g., metal conductors, metal or oxide resistors, and oxide dielectrics) melt at far higher temperatures. When such materials are to be formed into devices, their crystals or grains must have continuity with each other for electrical contact and with the substrate for adhesion. Continuity generally requires that individual particles be sintered into one conjoined structure. In turn, the methods by which continuity may be achieved all require high temperatures approaching the melting point of the bulk material (Tₘ).

Therefore, the construction of high-Tₘ electronics components upon a low-Tₘ substrate presents a difficult materials-science challenge. A need also exists for protecting a substrate from laser damage during the laser sintering process.

### SUMMARY OF THE INVENTION

The present invention is a method and apparatus for laser sintering of materials that provides complete sintering throughout the material and that enhances adhesion of the material to the substrate. Lasers may be used to sinter materials of interest to electronics applications.

The laser interacts with both the material to be sintered and the substrate upon which the material is positioned. This allows for a more complete heating process. The top of the material is heated via the laser and the bottom of the material is heated via the substrate. As the sintering occurs, the thermal spread throughout the material allows for sintering to occur completely through the material. This also enhances the adhesion significantly since the temperature difference between the substrate and the material are the same. If they are different, the temperature gradient stops the adhesion. This technique “fixes” both of the aforementioned limitations.

The present invention allows the laser to interact with both the target material to be sintered and the substrate upon which it rests with controlled exposure times. This controlled dual interaction provides a more complete heating process. The top of the target material is heated by the laser, the bottom portion via the heated substrate. Diffusion of heat allows sintering to occur throughout the material. This controlled-dual-interaction procedure also significantly enhances adhesion because no temperature gradient exists between the substrate and the sintered material. Temperature gradients may interfere with adhesion. The laser-sintering technique of the present invention solves the aforementioned problems.

The present invention also includes a method and apparatus for protecting a substrate from laser damage during a laser sintering process. The present invention protects a low-Tₘ substrate with a thermal barrier coating designed to shield it from high temperatures. With such a thermal barrier in place, the electronics materials may be sintered into functioning components without damage to the substrate. This thermal barrier method works especially well with such deposition methods as laser-assisted chemical vapor deposition (LCVD) or laser sintering, in both of which laser irradiation provides a highly localized region of high temperatures.

A protective layer is placed on top of a low temperature substrate to provide a protective thermal barrier. The thermal barrier allows for exposure to much more intense laser irradiation, thereby aiding in the sintering of deposited materials. The thermal barrier may be applied to any material. Several benefits are provided by the use of a thermal barrier on a substrate during a laser sintering process. One benefit is that the substrate is protected from the excessive heat of the laser sintering process. A second benefit is that adhesion of the deposited material to the substrate is enhanced.

These and further and other objects and features of the invention are apparent in the disclosure, which includes the above and ongoing written specification, with the claims and the drawings.

### BRIEF DESCRIPTION OF THE DRAWINGS

FIG. 1 is a cross-section of a line of silver paste that has been sintered.

FIG. 2 is a top view of a line of silver paste that has been sintered.

FIG. 3 is a graph of laser pulse duration vs. laser penetration depth into a material.

FIG. 4 is a diagram of an alumina substrate with parallel silver tabs that are perpendicular to the laser scanning direction.

FIGS. 5A and 5B are plots of laser voltage and temperature vs. time for open and closed loop feedback.

FIG. 6 is a perspective view of a laser sintering apparatus that is controllable through a CAD/CAM interface.

FIG. 7 is a diagram of a simulation geometry of a stack-up of silicon, aerogel, and silver to be sintered by a laser process.

FIG. 8 is a graph of power density vs. pulsing time showing the maximum silver temperature with a 1 μm layer of aerogel.

FIG. 9 is a graph of the power required to raise a silver layer to its melting point as a function of pulse time and power intensity.

FIG. 10 is a graph of the power required to raise a silver layer to its melting point and a silicon substrate to 400 K with a 1 μm aerogel layer as a function of pulse time and power intensity.

FIG. 11 is a graph of the power required to raise a silver layer to its melting point and a silicon substrate to 400 K with a 10 μm aerogel layer as a function of pulse time and power intensity.

FIGS. 12A and 12B are perspective views of silver line laser-sintered onto a plastic substrate.

### DETAILED DESCRIPTION OF THE PREFERRED EMBODIMENTS

The laser processing of materials involves consideration of several aspects of the target material. First, the laser-power density (Φ) needed to accomplish laser sintering is strongly dependent upon the light-absorption characteristics of the material, chiefly absorptivity (α), which is in turn dependent upon temperature (T), light wavelength (λ), and light temporal pulse width or duration (τ). Materials are used for which the sintering temperatures (Tₛ) are much lower than their bulk melting points (Tₘ). However, the present invention provides a method of laser sintering of any material without damaging the substrates upon which they rest. Typical values for some materials of interest are listed in Table I.

The effects of low a at a particular λ have significant consequences. The initial material dispensed is composed of various compounds and solvents, all of which change the absorption behavior of the composite. The initial composite is “wet” and must be treated appropriately. If not, the laser may “splatter” the paste and destroy the device. A drying process must be used to reduce the solvent concentration; however, even small amounts of remaining solvent often strongly absorb the laser.

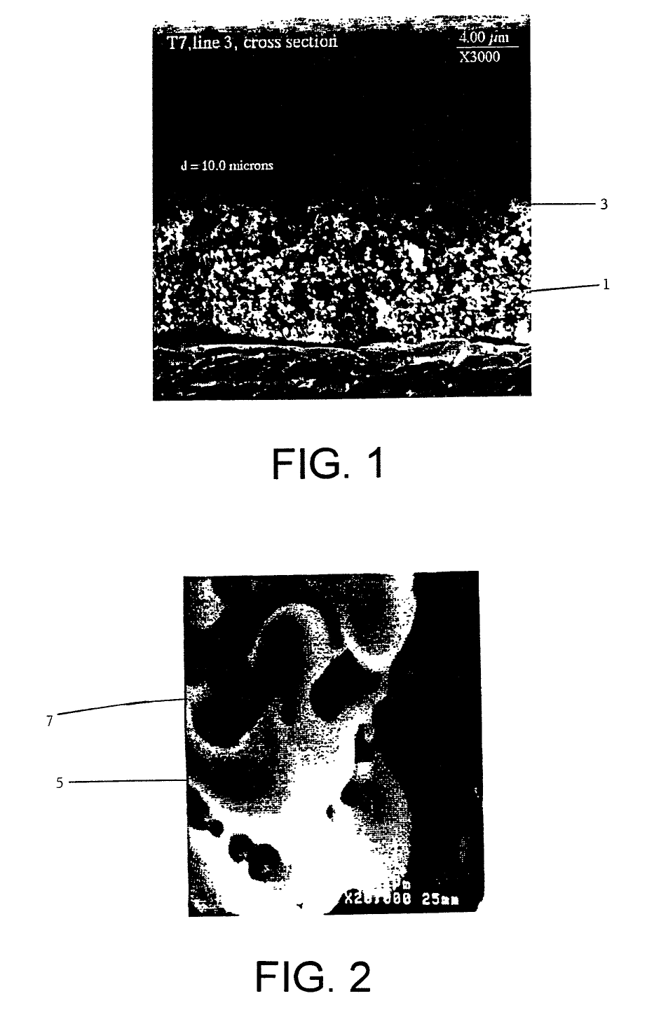

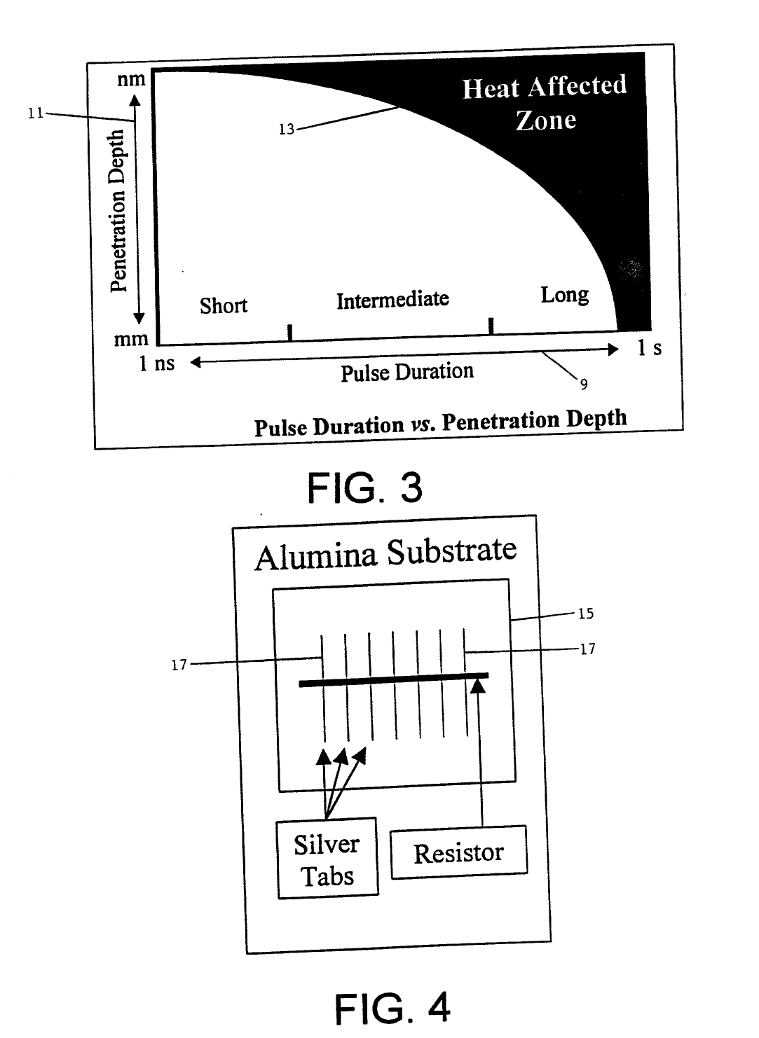

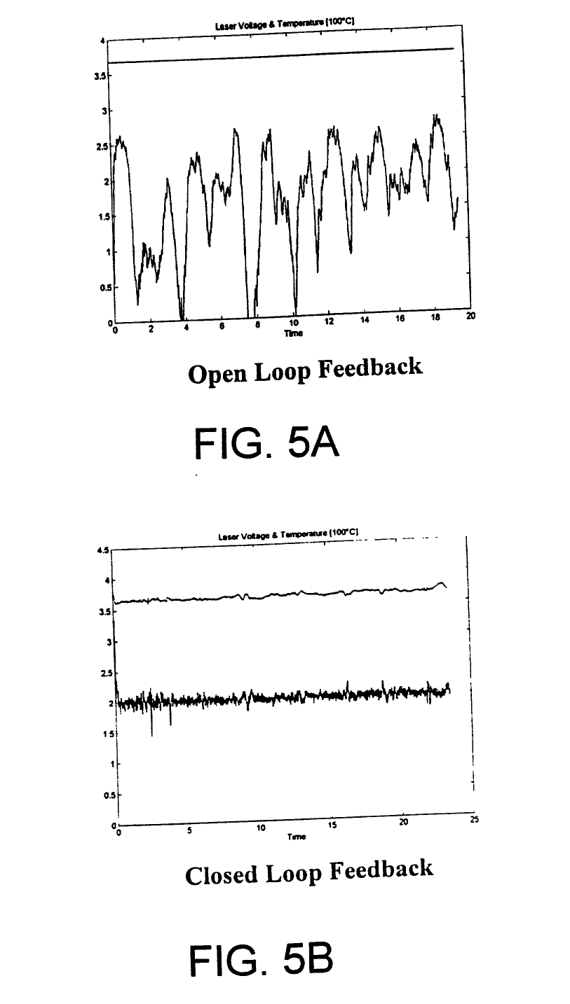

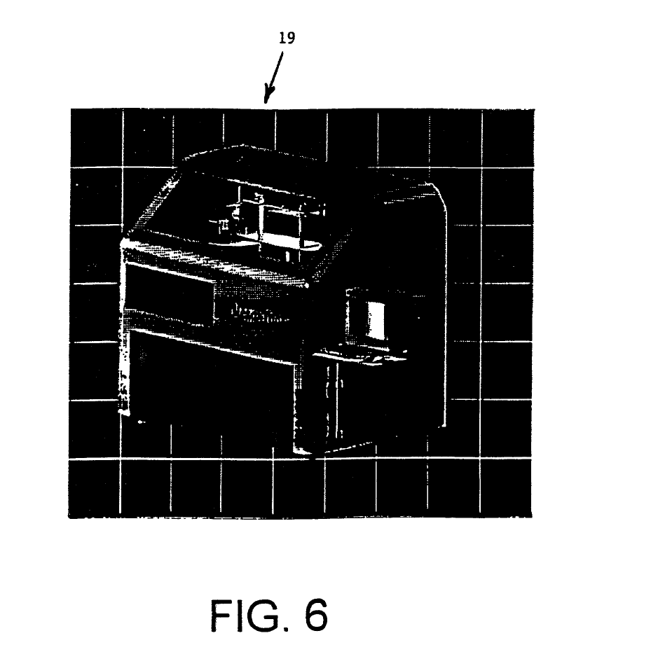

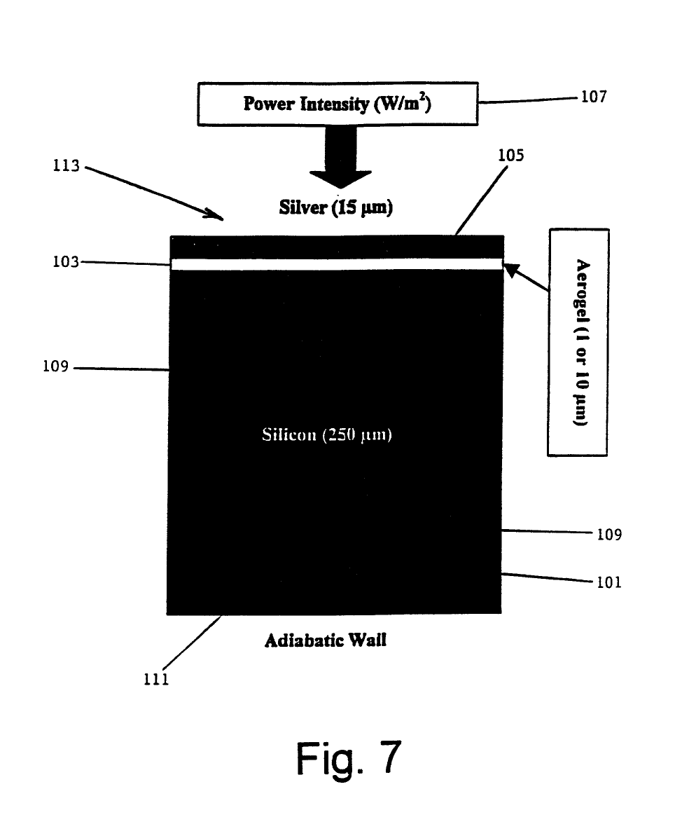

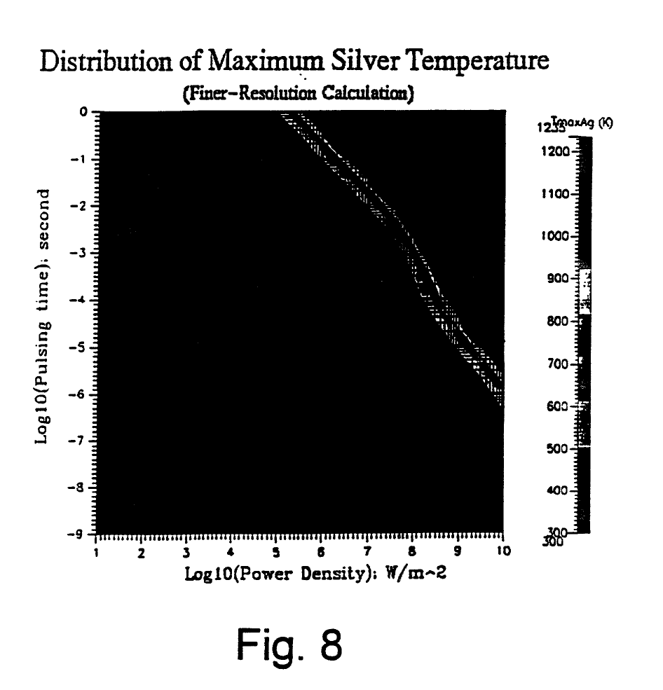

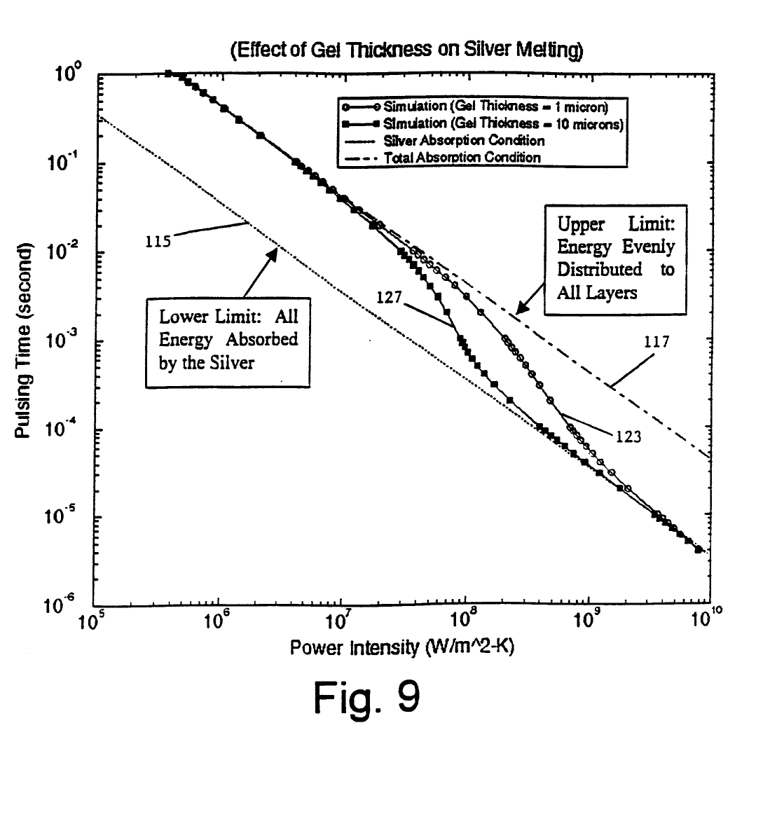

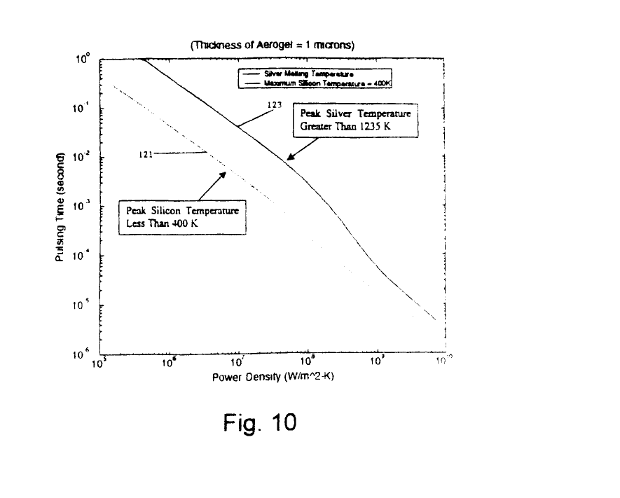

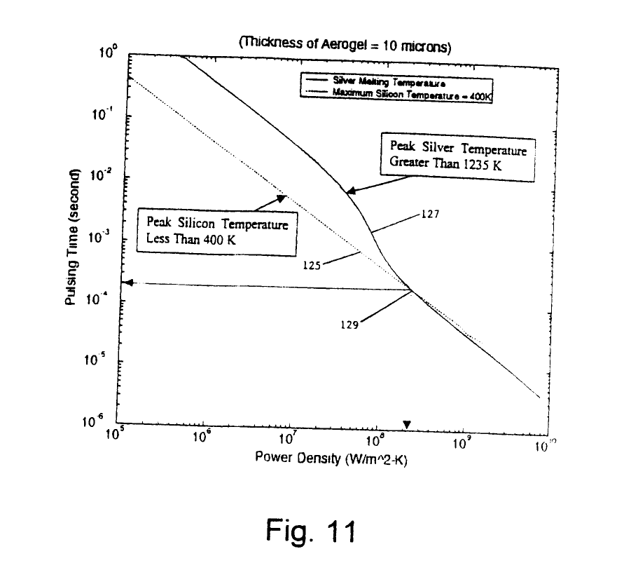

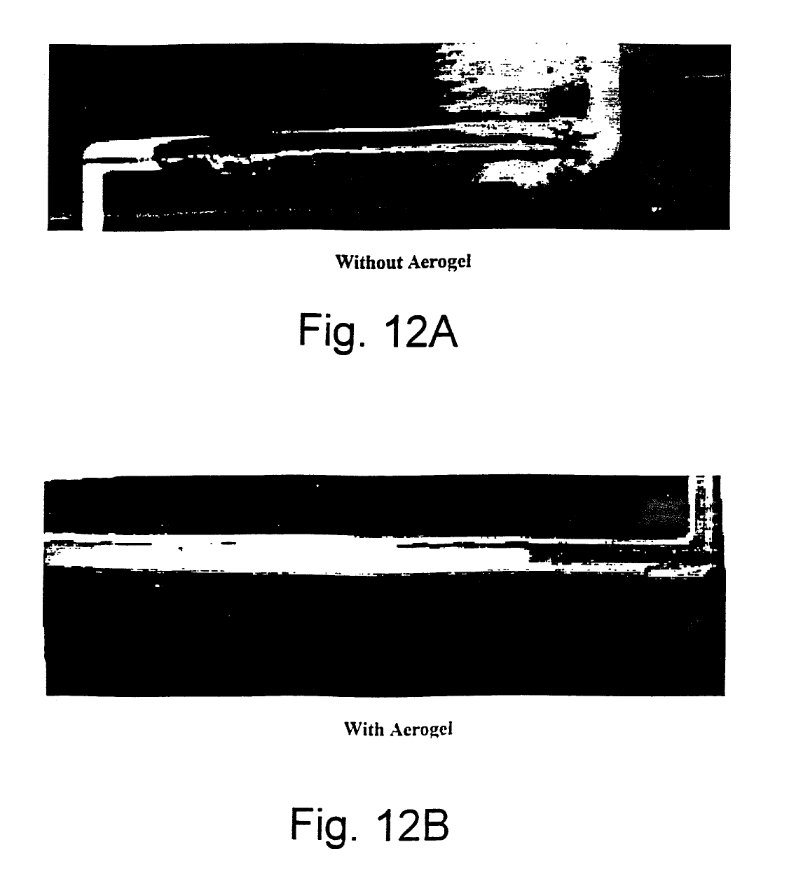

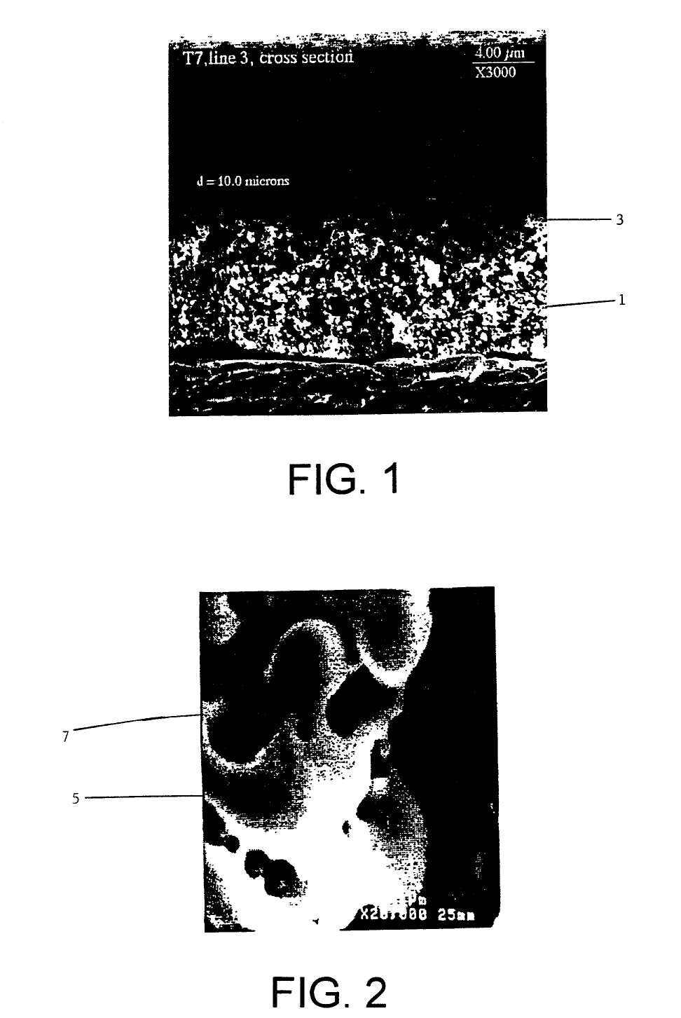

The interaction of the laser light and matter causes the sintering process to begin. In the example shown in FIG. 1, a continuous-wave (CW) C0₂ laser (λ=10.6 μm) was used to sinter silver paste 1. It should be noted that the only portion actually sintered is a thin layer 3 at the top of the material 1. Once the top few layers of the material 1 are sintered, they form a highly reflective mirror at λ=10.6 μm, which diverts the laser energy and prevents sintering from occurring throughout the deposit.

With a laser, it is possible to inject a tremendous amount of energy, which translates to heat, into a material. Once the absorption behavior is known (more is better), then the effects of pulse duration (τ) must be determined. Peak powers (Pₘₐₓ) in the gigawatt range are obtainable using lasers with low energy per pulse but very short pulses. Tradeoffs must be made to optimize τ. Shorter τ yields higher Pₘₐₓ but this works adversely with penetration depth (δ) in that shorter τ yields shorter δ. Therefore, if τ is too short, the interaction is confined to the surface 5 of the target material 7, as occurred with the sample shown in FIG. 2. In that case, a silver paste 7 sintered with a pulsed laser, a XeCl excimer (λ=308 nm), the top 5 of the paste deposit 7 was sintered but not the bottom or middle. The fact that a very thin layer was sintered demonstrates that a strong interaction exists between the silver and the 308-nm laser; however, τ was too short for deep and complete penetration.

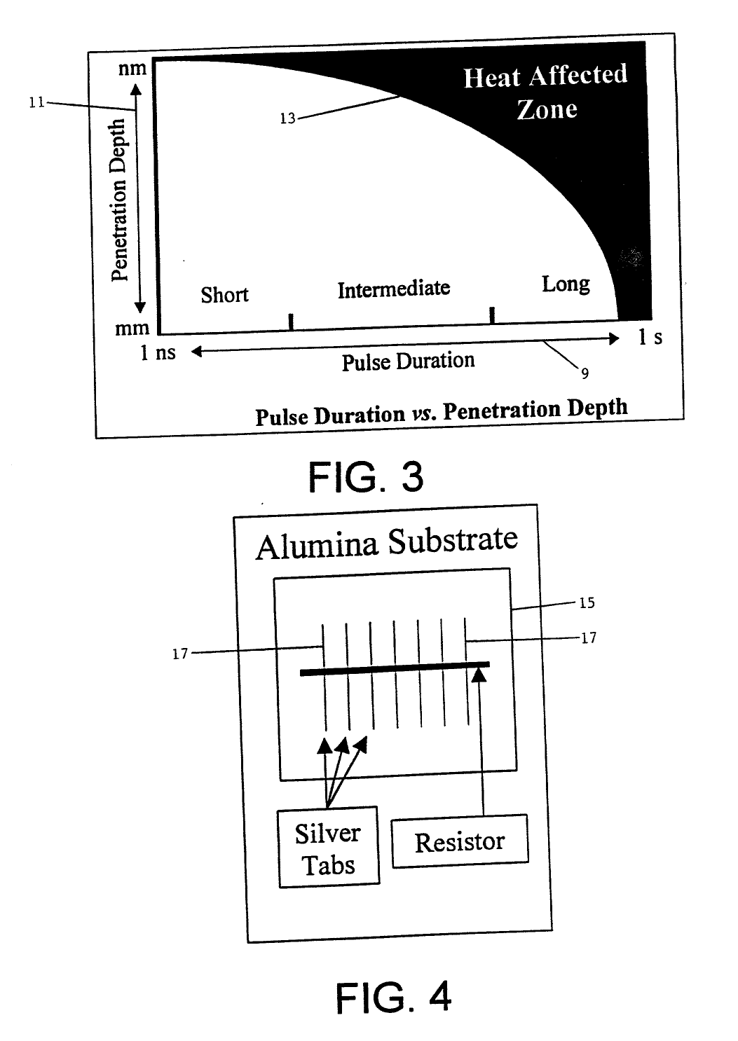

If τ9 is extended out to infinity (τ=∞), i.e., CW mode, then the interaction area extends completely through the paste, into the substrate, and even through the substrate. Therefore, it should be possible to control δ11 (penetration depth plotted on the vertical axis) by controlling τ9 (pulse duration plotted on the horizontal axis), as illustrated in FIG. 3. As is shown on the curve 13, as the pulse duration lengthens, the penetration depth becomes larger. Note that the penetration depth increases as you move down the vertical axis.

The propagation behavior of the thermal wave throughout the sample material was verified with a thermal-imaging camera. The longer the pulse, the farther the thermal wave traveled. Controlling τ enables δ to be made the same as the thickness of the material (θ). Several nontrivial factors must be considered when implementing this into a CAD/CAM program. They must even be considered in a laboratory setting if reproducibility is a requirement. The best way to ensure reproducibility is through a feedback control system. Such a system has been implemented by using a pyrometer with a relatively small (25 μm) spot size. While many pyrometers are available in the market today, the combination of small spot size and low temperature range is unique.

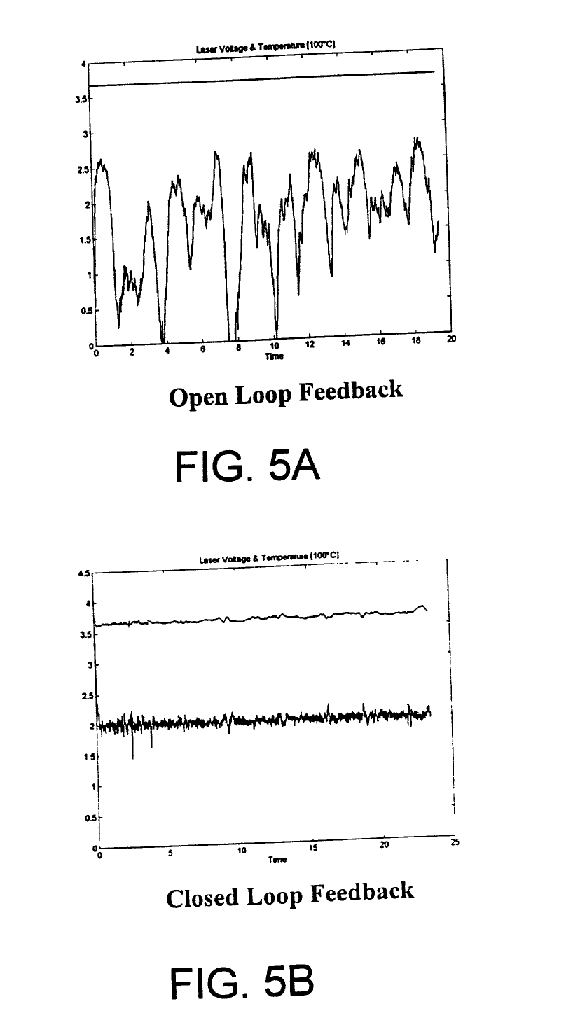

The output of the pyrometer was sent to the same computer that controls the output of the laser. The effectiveness of this method was demonstrated by setting the laser power to a constant value, then scanning it across a substrate 15 containing metal lines 17 parallel to each other and perpendicular to the laser scanning direction, as shown in FIG. 4. The output of this experiment showed dramatic differences and verified the effectiveness of active thermal feedback in controlling the power of the laser. FIGS. 5A and 5B show the results of open and closed loop feedbacks, respectively.

The present invention also includes a machine tool that implements the materials and the laser processes. The present invention allows its end user to interface to CAD/CAM, allowing for a fully automated machine needing very little interaction with or expertise by the user. The apparatus is capable of depositing and processing the desired materials over “any” surface with resolutions as small as 10 μm.

The present invention is capable of depositing lines as small as 75 μm. With the right paste, the shape of the line may be held. The apparatus may write on flat, slightly angled, or dipped surfaces. Preferably, the apparatus has a vertical travel of approximately 1 mm with good precision. In another embodiment, the apparatus is capable of writing over much larger vertical changes.

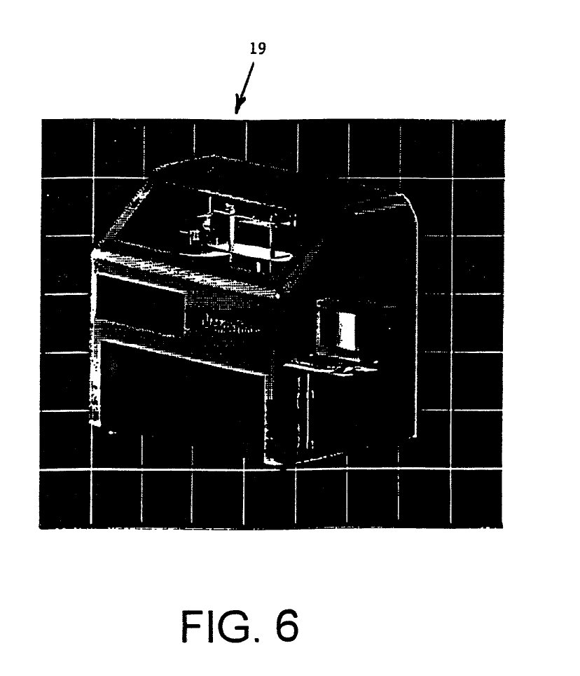

FIG. 6 is a perspective view of a preferred embodiment of the apparatus 19 of the present invention. The apparatus includes a drying process and two lasers found necessary to cut, drill, and sinter all of the electronics materials, which have large variations in light-absorption behavior. Preferably, the two lasers used are a C0₂ laser and a diode-pumped Nd:YVO₄ laser. As noted previously, the C0₂ laser emits radiation of λ=10.6 μm, which is relatively long and is conveniently absorbed by many materials. The Nd:YVO₄ laser emits near-infrared radiation at λ=1.06 μm; while the base wavelength is not optimal, it may be frequency-upconverted via nonlinear optics into ultraviolet radiation of λ(3υ)=355 nm or λ(4υ)=266 nm to reach desired absorption windows. The apparatus also includes a computer so that a user may interface with CAD/CAM software, allowing for a fully automated machine needing very little interaction with or expertise by the user.

The present invention also provides a protective layer that is placed on top of a low temperature substrate to provide a protective thermal barrier. The thermal barrier allows for exposure to much more intense laser irradiation, thereby aiding in the sintering of deposited materials. The thermal barrier may be applied to any material. Several benefits are provided by the use of a thermal barrier on a substrate during a laser sintering process. One benefit is that the substrate is protected from the excessive heat of the laser sintering process. A second benefit is that adhesion of the deposited material to the substrate is enhanced.

One preferred thermal barrier material is an aerogel. An aerogel coating was placed onto some typical low-Tₘ circuit board laminate samples. A simple device was constructed and laser-sintered on thermal-barrier-coated and uncoated substrates. The coated substrate suffered significantly less damage than did the uncoated substrate.

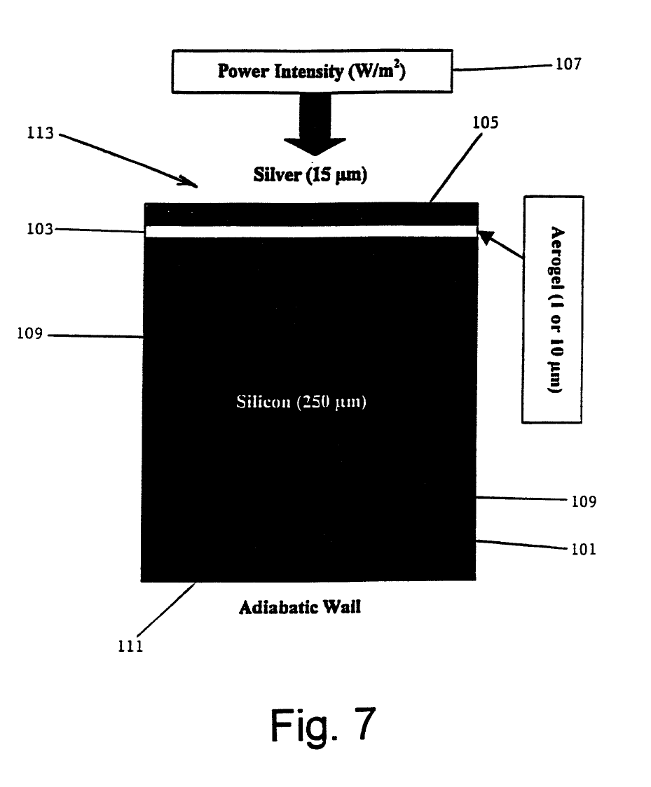

A series of one-dimensional rapid thermal processing (RTP) simulations were performed for the geometry shown in FIG. 7 using the data listed in Table II. The purpose of these simulations was to investigate the potential benefits of aerogel as an insulator and to develop an approach for characterizing multilayer processing.

In the simulations, a stack-up 113 of a silicon substrate 101, an aerogel thermal barrier 103, and a silver deposition material 105 was pulsed once with a uniform distribution of power density (in W/m²) 107. The intensity and duration of the pulse was varied. The sides 109 and bottom 111 of the stack 113 are assumed adiabatic. As such, all the energy of the pulse remains in the stack 113. The results of interest are the maximum temperatures that occur in each layer as a function of pulse length and intensity.

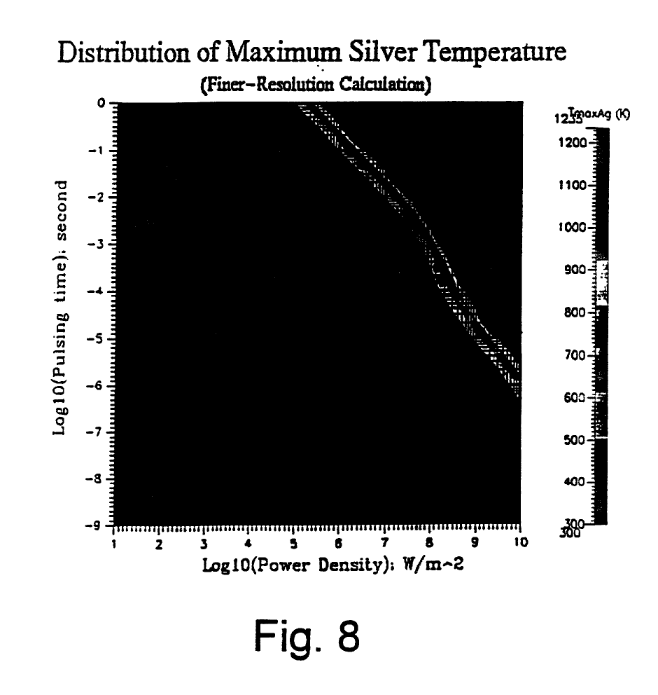

FIG. 8 shows the maximum silver temperature as a function of the pulsing time and power density for the configuration with a 1-μm layer of aerogel. The total energy per unit area (Eᵢₙ) deposited into the stack is the product of the pulse duration (τ) and power density (Φ). At a low Eᵢₙ, the temperature of the silver remains near the initial temperature T₀=300 K. At a higher Eᵢₙ, the temperature of the silver exceeds Tₘ=1235 K. In between these two extremes, the maximum silver temperature ranges between 300 K and Tₘ. The isotherms depend not only on the total energy but also on the combination of pulse and intensity used to input that energy. Note that temperatures computed as above Tₘ were reset to 1235 K.

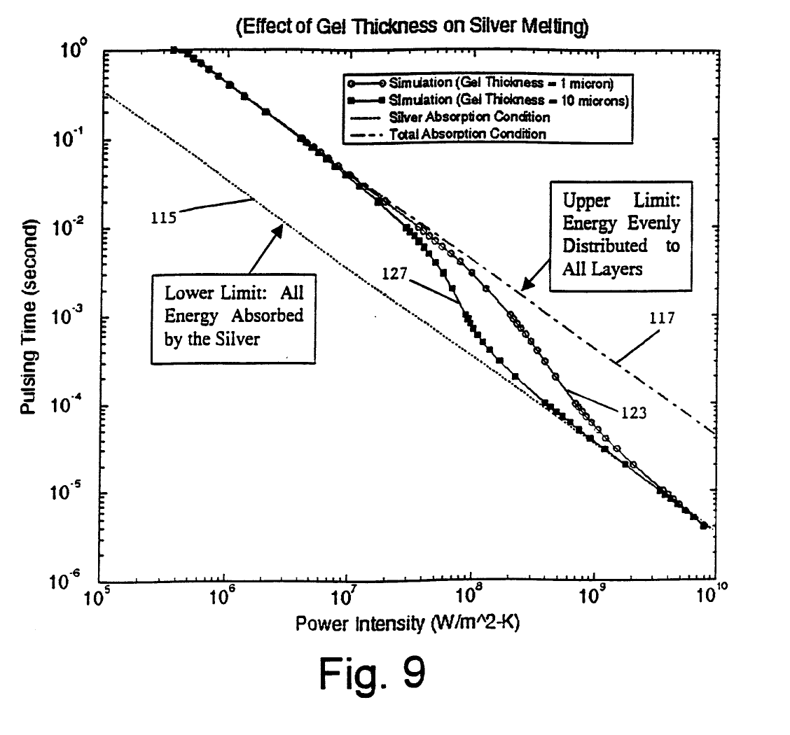

When the energy was added in a short burst, it was fully absorbed by the top layer of silver 105 before it had time to diffuse through the aerogel 103 into the substrate 101. Conversely, adding the same energy over an extended period allowed the energy time to conduct to the substrate 101, thus evenly heating all layers 101, 103 and 105. The bounding, straight lines 115 and 117 on FIG. 9 correspond to these two extremes. The lower bound 115 is the Eᵢₙ needed to heat the silver to Tₘ if all the energy went into the silver. The upper bound 117 is the Eᵢₙ that would be required to melt the silver if that energy were distributed to all layers. As expected, more energy is required to melt the silver if some of the energy is distributed to other materials.

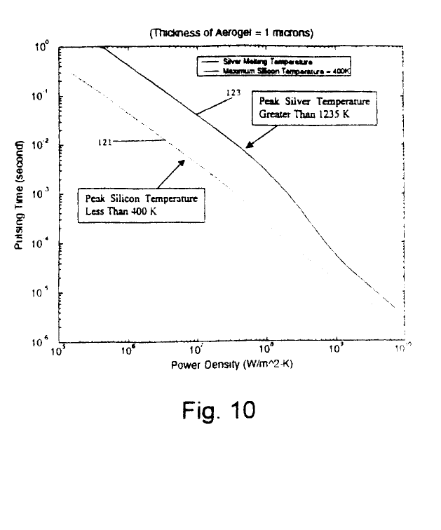

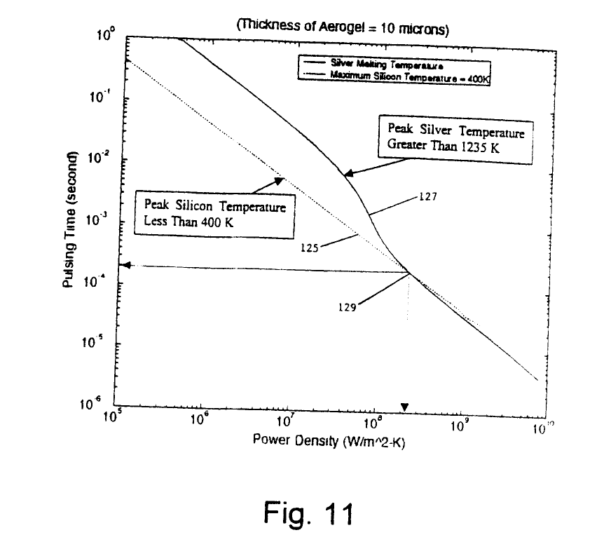

In between these two bounds 115 and 117, the actual energy required to bring the silver to melting depends on the combination of pulse duration and intensity used. Furthermore, the transition from one limit to the other depends on the thickness of the insulating layer 103 between the substrate 101 and the silver 105. FIGS. 10 and 11 show the computed energy required to obtain the silver melting point as a function of intensity and pulse duration for two different geometries, aerogel layers of 1 and 10 μm.

The combination of pulse duration and intensity used to bring the silver to its melting point becomes critical when the peak temperatures of other layers are of concern. For example, FIG. 10 includes a plot of the combinations of duration and intensity required to heat the silicon substrate to 400 K for the stack-up with a 1-μm thickness of aerogel, represented by curve 121. When this curve 121 is compared with the corresponding melting-point curve 123 for silver, the conclusion is that no combination of pulse duration and intensity can satisfy the dual requirement that the silver be heated to 1235 K while the silicon substrate be maintained at or below 400 K. However, this condition is met if the thickness of the aerogel is increased to 10 μm, as indicated by the overlapping curves 125 and 127 at point 129 in FIG. 11.

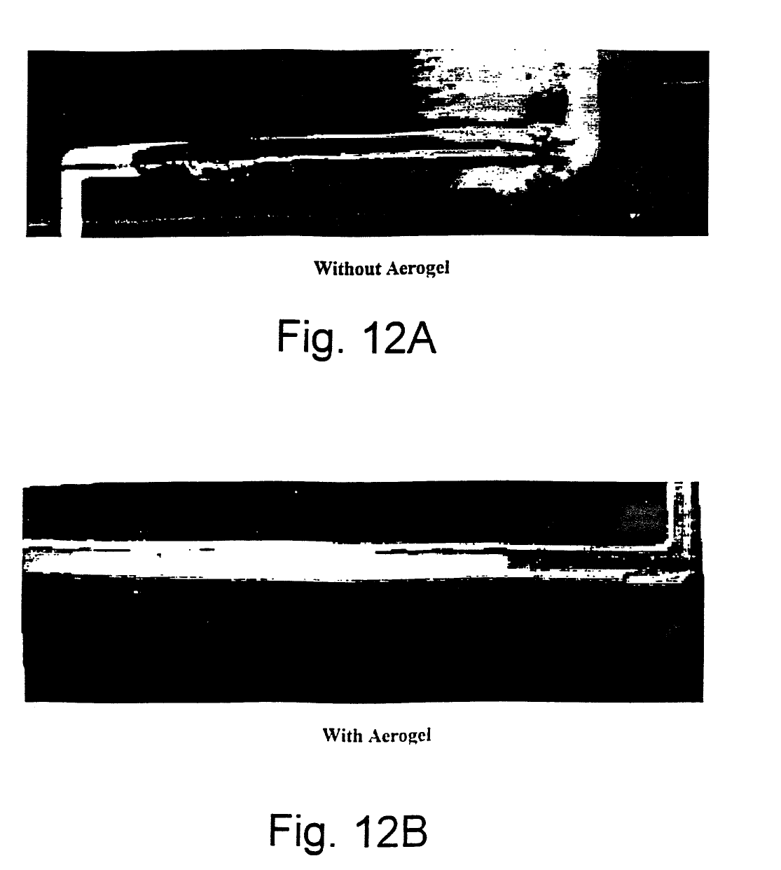

After an aerogel layer put on a substrate to protect its surface was tested in simulation, the aerogel layer was then tested on simple electronic components. In a trial study illustrated in FIGS. 12A and 12B, the component was a silver conductor line. The aerogel-silver composite was observed to interact strongly with a laser (any laser). If the component placed on top of the aerogel protector is too thin, the laser will damage the aerogel layer, but not the substrate. If the laser interacts only with the component and not the aerogel, the presence of the aerogel layer becomes a significant advantage. As shown in FIGS. 12A and 12B, a laser-sintering test run on a silver conductor with and without an aerogel layer, holding the laser power constant on both samples, produced readily apparent differences in results. The unprotected substrate shows considerable damage; the aerogel-protected one does not.

While the invention has been described with reference to specific embodiments, modifications and variations of the invention may be constructed without departing from the scope of the invention, which is defined in the following claims.

We claim:

1. A laser sintering method, comprising providing a material on a substrate, completely sintering the material on the substrate and enhancing adhesion of the material to the substrate without damaging the substrate.

2. The method of claim 1, wherein the sintering comprises providing a laser for sintering the material.

3. The method of claim 2, wherein the sintering comprises interacting energy from the laser with the material to be sintered and with the substrate thereby allowing for a complete heating process.

4. The method of claim 3, further comprising heating a top of the material by the laser, heating a bottom of the material by the substrate, and allowing a thermal spread throughout the material for sintering of the material completely.

5. The method of claim 4, further comprising controlling adhesion of the material on the substrate by maintaining a similar temperature between the substrate and the material for enhancing adhesion.

6. The method of claim 5, wherein the controlling further comprises stopping the adhesion by causing a temperature difference between the substrate and the material such that a temperature gradient stops the adhesion.

7. The method of claim 2, wherein the sintering comprises interacting the laser with the material and the substrate with controlled exposure times for providing complete heating.

8. The method of claim 7, further comprising allowing diffusion of heat for sintering throughout the material.

9. The method of claim 7, wherein the sintering comprises injecting high energy into the material with the laser and translating injected energy to heat.

10. The method of claim 9, further comprising determining absorption behavior and determining effects of pulse duration.

11. The method of claim 10, further comprising obtaining peak power in a gigawatt range with low energy per pulse and with short pulses.

12. The method of claim 10, further comprising controlling and optimizing pulse duration.

13. The method of claim 12, wherein the controlling comprises providing shorter pulse duration, confining interaction of the laser energy to a surface of the material on the substrate and sintering a thin top layer of the material but not a middle layer or a bottom layer of the material.

14. The method of claim 12, wherein the controlling comprises providing shorter pulse duration thereby controlling penetration depth of the energy into the material for sintering the material as desired.

15. The method of claim 14, wherein the controlling comprises controlling the pulse duration and making the penetration depth equal to a thickness of the material.

16. The method of claim 10, further comprising monitoring behavior of thermal wave of the energy throughout the material with a thermal-imaging camera.

17. The method of claim 1, further comprising coating the substrate with a shield and protecting the substrate from laser damage during the sintering process.

18. The method of claim 17, wherein the coating with the shield comprises coating the substrate with a thermal barrier coating and protecting the substrate from damage.

19. The method of claim 18, further comprising forming electronic components by the sintering while protecting the substrate from damage.

20. The method of claim 18, wherein the substrate is a low temperature substrate.

21. The method of claim 2, wherein the sintering comprises sintering at least one thin top layer of the material.

22. The method of claim 21, further comprising forming a highly reflective mirror with the sintered top layer, reflecting and diverting energy from the laser, and preventing sintering from occurring throughout the material deposited on the substrate.

23. The method of claim 22, further comprising ensuring reproducibility through a feedback control system.

24. The method of claim 23, wherein the feedback control system is a pyrometer having a small spot size.

25. The method of claim 23, further comprising providing an output of the pyrometer to a computing device.

26. The method of claim 25, further comprising controlling the laser with the computing device responsive to a processing of the output for an active thermal feedback in controlling the laser.

27. The method of claim 26, wherein the feedback is open-loop or closed-loop feedback.

28. The method of claim 26, further comprising providing an interface for real time use by end users.

29. Apparatus for sintering, comprising a substrate, a material to be sintered on the substrate, and at least one laser for sintering the material.

30. The apparatus of claim 29, wherein the at least one laser comprises a laser selected from the group consisting of C0₂ laser, diode-pumped Nd:YVO₄ laser, and combinations thereof.

31. The apparatus of claim 29, further comprising a computing device for receiving and processing data and automatically controlling sintering operation.

32. The apparatus of claim 29, further comprising a protective layer on the substrate.

33. The apparatus of claim 30, wherein the substrate is a low temperature substrate and wherein the protective layer is a protective thermal barrier for preventing damage to the substrate during sintering and for enhancing adhesion of the material to the substrate.

34. The apparatus of claim 33, wherein the thermal barrier is an aerogel.

35. The apparatus of claim 33, wherein the substrate, the material, and the protective thermal barrier form an electronic component.

36. The apparatus of claim 31, further comprising a feedback control system coupled to the computing device.

37. The apparatus of claim 36, wherein the feedback control system is a pyrometer with a small spot size.

38. The apparatus of claim 37, further comprising output from the pyrometer being provided to the computing device for processing and controlling an output of the laser.

39. The apparatus of claim 36, wherein the feedback control system is an open-loop feedback system.

40. The apparatus of claim 36, wherein the feedback control system is a closed-loop feedback system.

41. The apparatus of claim 29, wherein the material has a shape.

42. The apparatus of claim 29, wherein the substrate has a shape.
